(19) United States
(12) Patent Application Publication
(10) Pub. No.: US 2014/0302464 A1
(43) Pub. Date: Oct. 9, 2014

(54) SYSTEM AND METHOD FOR LEARNING FOREIGN LANGUAGE OVER A SECURED SOCIAL NETWORK BASED ON BILINGUAL MESSAGING

(71) Applicant: Don Xiangdong Cai, Vancouver (CA)

(72) Inventor: Don Xiangdong Cai, Vancouver (CA)

(21) Appl. No.: 14/248,251

(22) Filed: Apr. 8, 2014

Related U.S. Application Data
(60) Provisional application No. 61/810,174, filed on Apr. 9, 2013.

(51) Int. Cl. G09B 5/04

(52) U.S. Cl. CPC G09B 5/04
USPC 434/157

(57) ABSTRACT

A system and method for encouraging communication in different languages over a secured network that connects social circles (e.g., schools, kindergartens, etc.) and remote participants who are engaged in learning from each other's native languages as foreign languages are provided.

### CROSS-REFERENCE TO RELATED APPLICATION

This application claims priority to U.S. Provisional Patent Application No. 61/810,174, entitled “System and Method for Learning Foreign Language Over a Secured Social Network Based on Asynchronous Messaging,” filed Apr. 9, 2013, which is hereby incorporated by reference in its entirety for all purposes.

### TECHNICAL FIELD

The present disclosure relates generally to online learning, Electronic (E) Learning and Social Networking Service (SNS) Learning. More specifically, the present disclosure relates to a system and method for learning foreign languages over a network. The system and method may be particularly designed for kids (e.g., age 5-17).

### BACKGROUND

With increasing globalization, demand for foreign language fluency is drastically increasing. To compete in many job markets fluency in more than one language may be needed. Thus, more children are learning foreign languages all over the world.

Many children start learning a foreign language at a young age, such as in kindergarten or at school in their native countries where the foreign language is not commonly used. The benefits of learning foreign languages at a young age are tremendous. For example, children may naturally and intuitively absorb the sounds, structures, intonation patterns and rules of a second language rather than an adults who may have to study explicit grammar rules and practice role drills numerous times to learn a foreign language. Therefore, the trend of increasing numbers of children learning foreign languages is believed to continue. However, children may be faced with one of the most difficult problems of foreign language learning acknowledged by researchers and educators. For instance, learning English as a Foreign Language (EFL) in their native countries may be much more difficult than learning English as a Second Language (ESL) in an English speaking country. Therefore, a large number of children may become discouraged when learning a foreign language in their native countries using the current methodology and tools available to them. This problem has become a global issue for millions of children worldwide.

Some researchers on the subject matter, such as EFL learning, have concluded that the difficulty is mainly caused by the lack of intrinsic motivation and lack of foreign language exposure. Currently, most children in the world learning a foreign language don't have a chance to use it to communicate in their day to day lives, instead, their course of study is through textbooks, memorization, and exams. This is one of the root causes of the lack of intrinsic motivation. When it is combined with the lack of exposure to the foreign language, learning may become very difficult.

One previous attempt to solve these problems is to send the children abroad to learn a foreign language. However, only a limited number of children may have the opportunity to study abroad. Additionally, there is also a continuity problem associated with sending children abroad to learn a foreign language that decreases its effectiveness. Another previous attempt to solve the aforementioned problems is to provide virtual emersion of a foreign language environment through software simulation or language institutes. This attempt may be more scalable and effective in tackling the issue with lack of foreign language exposure and it has created a multi-billion dollar industry worldwide. However, it doesn't address the problem of lack of intrinsic motivation. Learning a foreign language is meant to communicate with the foreign language speaker to explore different cultures, to understand different worlds, to meet different people, etc. Studying abroad, software simulation and language institutes fail to solve both the problems of lack of intrinsic motivation and lack of foreign language exposure. Therefore, foreign language learning may be painful and hated by a large number of students, especially by children. Another previous attempt to help people to learn a foreign language by connecting users from different countries via general communication tools such as Skype or any social chat had also been proven to be ineffective. The reasons are lack of cultural context and lack of guidance. Without any innovate way to bridge the cultural context, a normal conversation for the purpose of language learning has proven to be extremely difficult for adults and impossible for kids. Without adequate guidance, users often feel lost in this complicated situation and feel frustrated and demotivated.

### SUMMARY

A system and method are provided that will motivate peopled to learn foreign languages, by providing a personable learning experience as well as creating a continuous environment to encourage global participants to communicate in a mixture of different languages. For instance, a child in China whom has started to learn English at school may be connected, over a network, with a child of the same age group in the US whom is learning Chinese as a foreign language in school over the system described herein. To provide learning network security, the system may automate the verification process of the participating schools and the verification of participant's true identity within the schools. The system may also automatically make a recommendation of learning partners based on a matching algorithm and provides a face behind the foreign language that is being learned. The matching algorithm may take into consideration various characteristics (e.g., interest topic selection, age, interests, grade, language level, gender, geographical location, network connection speed, etc.,) to come up with the best recommendation. The system may also automate a process to verify a curriculum that's been taught at schools where the participants are learning the foreign languages. The system may also make suggestions to the participants about learning content based on the school curriculum, so as to bridge the on-line and off-line foreign language learning programs. Therefore, the system and method may also compliment the language teaching at schools and create a social learning environment among classmates. Furthermore, the system and method may leverage the power of Social Networking Service (SNS) technology to change the way people learn foreign languages in their native countries.

The system may be configured to automatically match participants based on common interests, such as topics selected by the participants. Subsequently the matched participants may communication via mixed language user interfaces executed via their respective client devices. In this way, a common interest may be used to guide a bilingual dialogue between two participants speaking different native languages through user interfaces. As a result, both peers can assist one another in learning a foreign language, thereby enhancing their language learning experience.

The system may automate a learning method called “Teach to Learn” in which it first guides a participant to show proper usage of native language and then to practice foreign language and get feedback and suggestions from a learning partner who speaks the foreign language natively. Then, the system guide them to reverses the role. This method may also motivate the participants to learn foreign languages. The system may provide a user interface and an asynchronous multimedia messaging service to encourage participants to communicate to each other in different languages. The multimedia messages may be composed of pictures or videos with text in different languages. The messages may be sent asynchronously over different time zones to one or a group of participants and can be re-posted, commented and/or voted on. It creates a continued foreign language environment about interesting things happening around the global without being lost in translation. As a result, the system can bring people from around the world together onto the innovative platform to learn from each other, to communicate to each other and to understand the different cultures from the first day when they start to learn foreign languages. Moreover, the system can overcome a barrier of space by creating a secured learning network. Furthermore the system can overcome a barrier of time by providing an asynchronous communication system. Still further, the system can overcome the barrier of foreign language by enabling people to share interesting information via pictures and videos with interesting people supervised by foreign language educators and parents. Therefore, the system fundamentally resolves the problem of lack of intrinsic motivation and exposure to learn foreign language, and will also enable a deeper understanding and appreciation of different cultures around the globe.

### BRIEF DESCRIPTION OF THE FIGURES

FIG. 1 shows a schematic depiction of a foreign language learning system.

FIG. 2 shows a plurality of modules included in the foreign language learning system shown in FIG. 1.

FIGS. 3 and 4 show methods for foreign language learning.

FIGS. 5-7 show example user interfaces which may be implemented as part of the method described in FIG. 4.

FIGS. 8-9 show additional foreign language learning methods.

FIGS. 10-15 show example user interfaces which may be implemented as part of the methods described in FIGS. 8 and 9.

FIGS. 16 and 17 show another method for foreign language learning.

### DETAILED DESCRIPTION

A system and method for encouraging communication and cultural exchange in mixed languages over a social network (e.g., a secured social network) among remote participants (e.g., global participants) who are engaged in learning foreign languages and culture from each other is described herein. The system and method may be globally implemented and may be configured to find well matched learning partners to learn foreign languages in a fun way and in a secured environment which may be monitored by educators and parents. In this way, foreign language learning and communication may be implemented between people who have similar interests, are of a similar age, and/or have a comparable language level, if desired. In the system, a social network for learning foreign languages may be established over a large geographical range (e.g., globally) by connecting local social circles (e.g., schools, kindergartens, foreign language centers, study groups, etc.,) where foreign languages learning occurs. Additionally, the system may automate the verification process of these social circles and the verification of a user's true identity within the social circles before it connects the users and the social circles into the social network, if desired. In this way, security may be enhanced in the system.

In one example, the system is configured to connect, over a network, a person A who is learning a foreign language X and is a native speaker of language Y to a person B who is a native speaker of language X and is learning language Y as a foreign language using a novel matching algorithm. The algorithm may verify the real identity (ID) of person A and person B to create a secured learning environment. The real ID may include name data, grade data, school data, teacher data, etc. Additionally, the system may connect person A and B by first connecting (e.g., globally connecting) their social circles (e.g., schools, learning centers, study groups, etc.) which are currently running a foreign language education program. The matching algorithm may be configured to automatically make learning partner recommendations. The recommendations may be based on selected topics of interest presented to the system participants via graphical user interfaces. In this way, partners can be matched via a common interest topic, providing common ground to enter into a mixed language conversation.

In one example, the matching algorithm may be based on an augmented interest graph. The augment interest graph may be generated based on an interest graph which is an online representation of the specific topics in which an individual is interested. Interest graph have perceived utility and value because of the premise that people's interests are a major aspect of who they are, forming part of their personal identity, and can be used as indicators of such things as what they might want to do, to talk about or to buy, where they might want to go, or who they might want to meet, follow or vote for. Interest graph are closely related to social graphs. Interest graph are used to create people's interest networks. Where social networks are organized around an individual's friends, or social graph, interest networks are organized around an individual's interests, their interest graph. Much as social graphs are maps of individuals' social media connections that follow them across the online and mobile network, interest graph as maps of individuals' interests can likewise follow them. In this way an individual's interests, as represented in an interest graph, provide a means of further personalizing the content based on intersecting the interest graph with online/mobile content. Interest graph or interest networks can in some cases be derived from social graphs or social networks and may maintain their context within that social network. These are specifically social interest graph or interest-based social graphs. For an interest graph to be accurate and expressive, it needs to take into account explicitly declared interests, for example “Likes” or “Interests” in social networking sites, as well as implicit interest inferred from user activities such as clicks, comments, photos (e.g., tagged photos) and check-ins. Social networks may be used as a source for this data. Social graphs and interest graph may be uniquely combined. This hybridization may create two results. One is called an “augmented social graph”, meaning that it relies on the interaction with friends for the application, but complements it with the opportunity to interact with strangers. And the opposite is called an “augmented interest graph”, making interaction with strangers based on their common interest the core of their user experience, but allowing users to introduce their social graph in the mix. Simply put, an “augmented interest graph” is when users become interested in something new due to a new or old relationship with other users. The “augmented interest graph” is a beneficial concept when it comes to cross-culture communication and interaction among users who share very little common interests to begin with, but will continue building the base of their common interests as these cross-cultural strangers becoming friends and also bringing in their old friends.

The system may also be configured to enable users to manually pick their learning partner. In this way, a well suited partner may be provided to give a face behind the foreign language that a participant is learning. By providing a learning partner to learn your native language as a foreign language enables the two matched partners to help each other and communicate about interesting things in foreign languages. Specifically, a database and a matching algorithm may also be provided in the system to help a participant find a well matched learning partner with verified identity and other matching attributes. In this way, a foreign language is no longer foreign, it has a face behind it.

The system may also automate the process to verify the curriculum that is taught at the school where the participant is learning the foreign language. Additionally, the system may make recommendations to the partners about learning content based on the curriculum, so as to bridge the on-line and off-line foreign language learning programs. In this way, the system may compliment the foreign languages study program offered by schools and gives the teachers a new method to motivate the students to learn and to monitor their progress. Therefore, the system encourages the use of content taught at school during the practice session among the users.

Additionally, the system may automate a learning method that first guides a participant to show proper usage of native language and then to practice foreign language and get feedback and suggestions from a learning partner who speaks the foreign language natively. Then, the system guide them to reverses the role. This method may also motivate the participants to learn foreign languages. The learning method may be referred to as “Teach to Learn”.

The system may also provide a user interface and an asynchronous multimedia messaging service to encourage participants to communicate to each other in mixed languages. The multimedia messages may be composed of pictures and/or videos with text in different languages. The messages may be sent asynchronously over different time zones to one participant or a group of participants and may be re-posted, commented, and/or voted on. In this way, a continued foreign language environment about interesting things happening around the globe is created without being lost in translation. The multimedia message exchanges may be done in two ways guided by the system. One particular way is called “Teach to Learn” in which the system guides a participant to teach the partner first in his native language and then learn from his partner the foreign language. The “Teach to Learn” method encourages the language teaching as a means to gain deeper understanding of how to learn. The other way to implement multimedia message exchange is for participants to exchange the multimedia messages on interesting topics among a group of participants. The content provided by the “Teach to Learn” and other message exchange method may be recommended by the system based on a database of information about the curriculums that are being taught at the schools where the participants are attending. Verified teachers can use the system and incorporate the “Teach to Learn” session as part of the academic program.

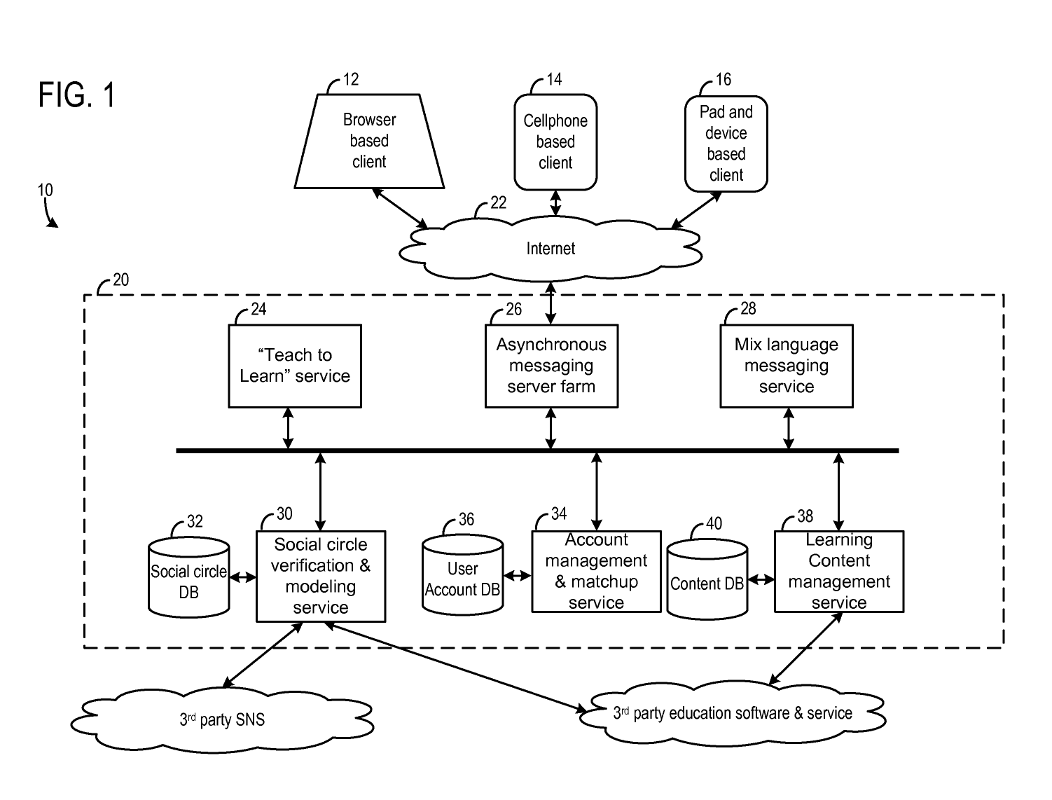

FIG. 1 shows an architecture diagram of a foreign language learning system 10 is shown in FIG. 1. The foreign language learning system 10 includes a foreign language learning platform 20. As shown, clients such as a browser based client 12, a cell phone (e.g., smart-phone) based client 14, and/or a pad & device based client 16 may be in electronic communication with the foreign language learning platform 20. It will be appreciated that other suitable clients may be in electronic communication with the foreign language learning platform.

As shown, the Internet 22 provides electronic communication between the clients and the foreign language learning platform. However, other suitable networks enabling electronic communication between the aforementioned components have been contemplated.

A “Teach to Learn” service 24 is included in the foreign language learning platform 20. The “Teach to Learn” service 24 is configured to guide a participant to give feedback and suggestions to a partner in his/her native language and then reverses the role to learn from his/her partner about the foreign language.

An asynchronous messaging server farm 26 may also be provided in the foreign language learning platform 20. The asynchronous messaging server farm 26 may be configured to enable a text, picture, and/or video exchange in an asynchronous manner between matched participants in the system. Asynchronous messaging may be defined as the transfer of data at non-regular time intervals. Specifically in one example, asynchronous communication may be a transmission of data, without the use of an external clock signal, where data can be transmitted intermittently rather than in a steady stream. A mixed language messaging service 28 is also provided in the foreign language learning platform 20. The mixed language messaging service 28 may be configured to provide communication via text, images, and/or video between two participants in two languages.

A social circle verification and modeling service 30 is also provided in foreign language learning platform 20, in the depicted example. The social circle verification and modeling service 30 may be configured to selectively enable communication between social circles (e.g., schools, language institutes, study groups, etc.). Additionally, the social circle verification and modeling service 30 may be configured to verify that a social circle meets predefined criteria to increase the security of the system. The predefined criteria may include information such as a school that is registered in the government database, or a school that is referred by another verified school, etc. The social circle verification and modeling service 30 may also be configured to access a social circle database 32. The social circle database 32 may stored social circle data corresponding to a plurality of social circles such as a grade of a social circle, a location of a social circle, teacher's information, curriculum taught by a social circle, etc.

An account management and match-up service 34 may also be included in the foreign language learning platform 20. The account management and match-up service 34 may be configured to automatically match participants for communication exchanges in native and foreign languages based on matching parameters such as topic selection, age, location, gender, grade level, language level, etc. The account management and match-up service 34 may be configured to access a user account database 36. The user account database 36 may store user account information such as user names, user identification numbers, a user's location, a user's language information (e.g., native language, foreign language), etc. The match-up service may utilize a matching algorithm based on common interest topics of the clients. For instance, an augmented interest graph may be used to determine matched clients.

A learning content management service 38 may also be included in the foreign language learning platform 20. The learning content management service 38 may be configured to provide lessons, drills, assisted conversations, etc., to the matched participants, in one example. Additionally, the learning content management service 38 is configured to access a content database 40. The content database 40 stores learning content such as curriculum taught at a social circle (e.g., lessons, drills, vocabulary, grammar, expression, etc.). It will be appreciated that the aforementioned services may interact with one another to implement the aforementioned functionalities.

A third party Social Networking Service (SNS) 42 and a third party education software and service 44 are also in electronic communication with the foreign language learning platform 20. The third party SNS 42 and the third party educational software and service 44 may be configured to collaborate on user verification, social circle verification, learning content collaboration, etc.

The browser based client 12, cell phone based client 14, and pad and device based client 16 may be generally referred to as language learning clients. Thus, in one example, the browser based client 12 may be a first language learning client and the device based client 16 may be a second language learning client, etc. It will be appreciated that the language learning clients may be any suitable computing device. The language learning clients may include various input devices such as a mouse, trackpad, trackball, keyboard, keypad, microphone, etc., and displays such as liquid crystal displays, organic light emitting diode (OLED) displays, touch sensitive displays, etc. Each client as well as the language learning platform may also include code stored in memory as instructions executable by a processor to implement the various functions, methods, etc., described herein. It will be appreciated that the types of memory and processors may vary between the clients and the platform, in one example. The language learning platform may also include input devices and displays, in one example.

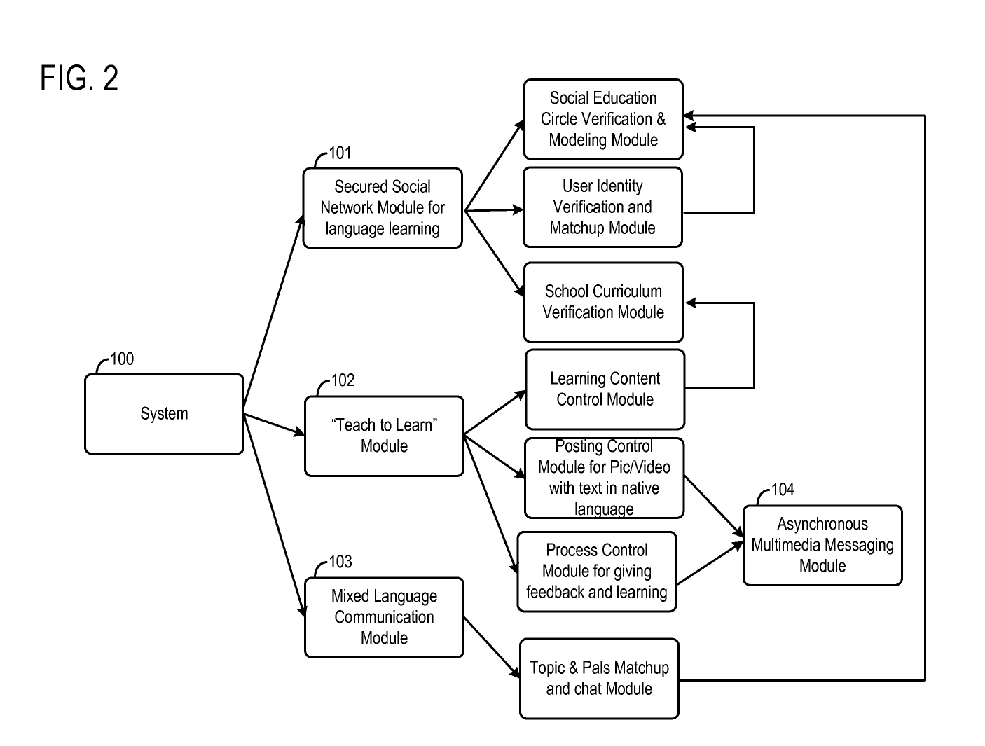

FIG. 2 shows a schematic depiction of modules that may be included in the foreign language learning system 10, shown in FIG. 1, and specifically the foreign language learning platform 20, shown in FIG. 1. Continuing with FIG. 2, the modules providing various functionalities to the system. Additionally, the modules may be software modules including instructions stored in memory executable by a processor. The modules may be provided via one or more servers or other suitable computing device assessable via a network, such as the Internet.

As shown, the system 10 includes a Secured Social Network Module for language learning 101, a “Teach to Learn” Module 102 and a Mixed Language Communication Module 103. The Secured Social Network Module for Language Learning 101 may include three sub-modules. Among them, the Social Education Circle verification module may be configured to automate the verification process of different social circles, such as schools or kindergartens or language institutes where the participants are currently learning the foreign languages. The User Identity Verification & matchup module may be configured to automate the process to verify the true identity of a user within the social circle. Additionally, the User Identity Verification & matchup module may be configured to allow a user to manually pick a language learning partner and may also be configured to automatically make learning partner recommendations to a client. The School Curriculum Verification module may be configured to automate a process to verify a curriculum that is used in schools or other suitable social circles where the user is learning the foreign language. The module makes recommendation to the partners about learning content based on the curriculum, so as to bridge the on-line and off-line foreign language learning programs.

Furthermore, the “Teach to Learn” Module 102 may include 3 sub-modules; a learning content module, a posting control module and a process control module. The learning content module may be configured to provide learning content to participants. The learning content may include vocabulary data, grammar data, etc. The posting control module may be configured to enable the participants to post text associated with a picture and/or video in communicatively linked graphical user interfaces, for example. The process control module may be configured to enforce the sequence of “Teach to Learn”. It may urge or in some cases require a participant to first give feedback about the correctness of the foreign language message written by the learning partner (i.e. to “Teach” first), and then compose a picture/video message with foreign language text in order to get feedback from the partner (i.e. to “Learn” later). The process control module may also be configured to enable a participant to give helpful feedback and be rewarded based on the vote from the recipient, and it may help the participants to compose a picture/video message.

The Mixed Language Communication Module 103 may also include one sub-module; the topic and pals matchup module. The topic and pals matchup module may be configured to enable participants to select a topic of interest from a list of topics provided by the system in form of photo or video with bilingual text and audio. Thus, the topics may be generated by the system. Additionally or alternatively, users may upload desired topics. The participants can then be matched up by the system with a group of participants from a foreign country who may also be interested in the selected topic. Then, the participants are encouraged by the system to send a message about the selected topic to the others in order to start the chat in mixed language.

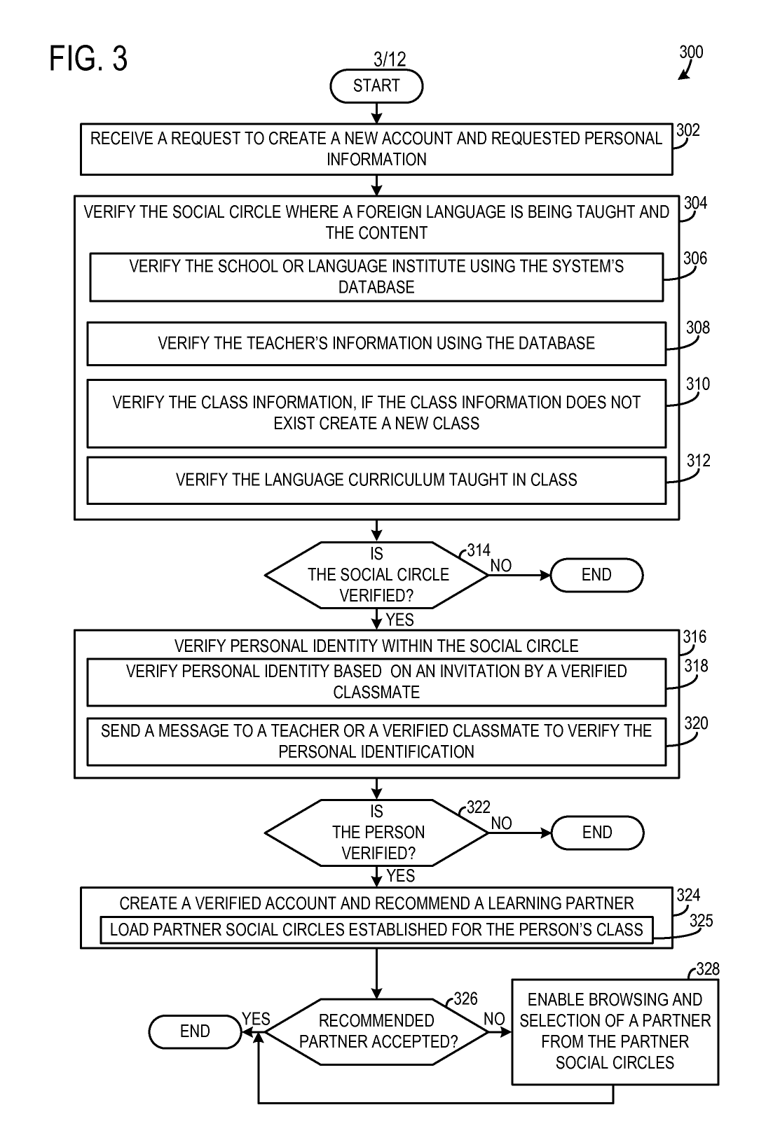

FIG. 3 shows a method 300 for learning a foreign language that includes steps 302-328. The method 300 may be implemented via the system, platform, components, modules, services, etc., described above with regard to FIGS. 1 and 2 or may be implemented via other suitable systems, platforms, components, modules, services, etc.

At 302 the method includes receiving a request to create a new account and requested personal information. Next at 304 the method includes verifying the social circle where a foreign language is being taught and the content. Verifying the social circle where a foreign language is being taught and the content may include verifying the school or language institute using the system's database at 306, verifying the teacher's information using the database at 308, verifying the class information, if the class information does not exist a new class is created at 310, and/or verifying the language curriculum taught in class at 312. Next at 314 the method includes determining if the social circle is verified. If it is determined that the social circle has not been verified (NO at 314) the method ends. In this way, unwanted participants may be excluded from interacting with the system, thereby increasing the system's security. However, if it is determined that the social circle has been verified (YES at 314) the method includes at 316 verifying personal identity within the social circle. Verifying personal identity within the social circle may include verifying personal identity based on an invitation by a verified classmate at 318 and/or sending a message to a teacher or a verified classmate to verify the personal identification at 320. In this way, the system's security is further enhanced.

At 322 the method includes determining if the person is verified. If the person is not verified (NO at 322) the method ends. However, if it is determined that the person is verified (YES at 322) the method includes creating a verified account and recommending a learning partner at 324. Creating a verified account and recommending a learning partner may include loading partner social circles established for the person's class at 325. The recommended learning partner may be well matched to the user. For example, user and the recommended partner may have a similar age, gender, grade level, language comprehension, etc. Next at 326 the method includes determining if a recommended partner is accepted. If a recommended partner is not accepted (NO at 326) the method includes enabling browsing and selection of a partner from the partner social circles at 328. In this way, the user may select their language learning partner based on their predilection.

After 328 the method ends. On the other hand, if a recommended partner is accepted (YES at 326) the method advances directly to 330 from 326. Steps 302-328 may be implemented via the Secured Social Network Module 101, shown in FIG. 2, in one example.

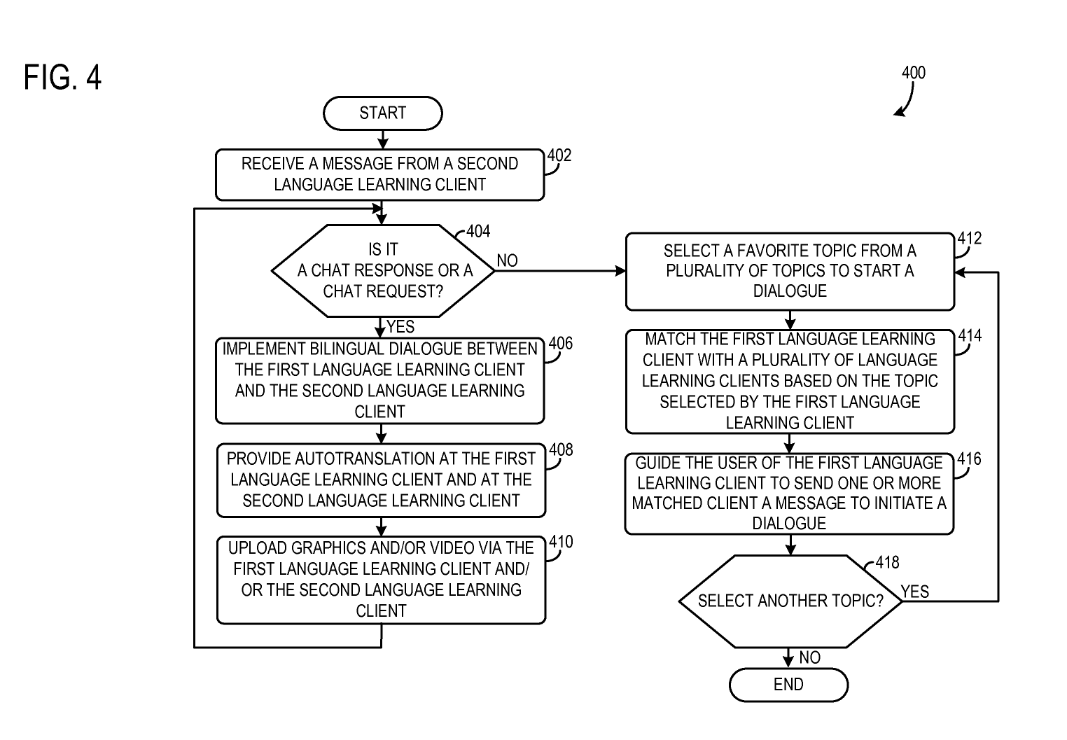

FIG. 4 shows a method 400 for foreign language learning. It will be appreciated that method 400 may be implemented subsequent to method 300 shown in FIG. 3 and in some cases in response to completion of method 300. However in other examples, method 400 may be implemented autonomously. The method 400 may be implemented via the system, platform, components, modules, services, etc., described above with regard to FIGS. 1 and 2 or may be implemented via other suitable systems, platforms, components, modules, services, etc. Specifically, it will be appreciated that the method may be implemented via a first language learning client and a language learning platform.

At 402 the method includes receiving a notification message at a first language learning client. The notification message may be a dialogue response (e.g., chat response) or a dialogue request (e.g., chat request) from a second language learning client or a notification message from a language learning platform.

Next at 404 it is determined if the notification message is a dialogue response or a dialogue request. If it is determined that the notification message is a dialogue response or a dialogue request (YES at 404) the method advances to 406 where the method includes implementing dialogue between the first language learning client and the second language learning client. In this way, pals may chat via the language learning clients. It will be appreciated that the clients may be recommended for chat via the method 300, in one example.

Next at 408 the method includes providing auto-translation at the first language learning client and/or the second language learning client. Next at 410 the method includes uploading graphics and/or video via the first language learning client and/or the second language learning client. After 410 the method returns to 404.

If it is determined that the notification message is not a dialogue response or a dialogue request (NO at 404) the method advances to 412 where the method includes selecting a favorite topic from a plurality of topics to start a dialogue (e.g., chat). It will be appreciated that the topics may be topic widgets displayed in a mixed language user interface displayed via the first language learning client. It will also be appreciated that the topic widget may include graphics (e.g., photos, drawings, etc.) and/or video, in one example.

At 414 the method includes matching the first language learning client with a plurality of language learning clients based on the topic selected by the first language learning client. In one example, language learning clients that selected similar (e.g., identical) and/or related topics may be matched-up. Next at 416 the method includes guiding the user of the first language learning client to send one or more matched clients a message to initiate a dialogue. It will be appreciated that the message may be related to the selected topic. Subsequently, the matched clients may have a bilingual dialogue (e.g., bilingual chat) via mixed language learning user interfaces.

At 418 it is determined if the first language learning client would like to selected a different topic. If it is determined that the first language learning client would not like to selected another topic (NO at 418) the method ends. However, if it is determined that the first language learning client would like to selected another topic (YES at 418) the method returns to 412. In this way, the first language learning client may be guided through topic based chat with a plurality of matched clients.

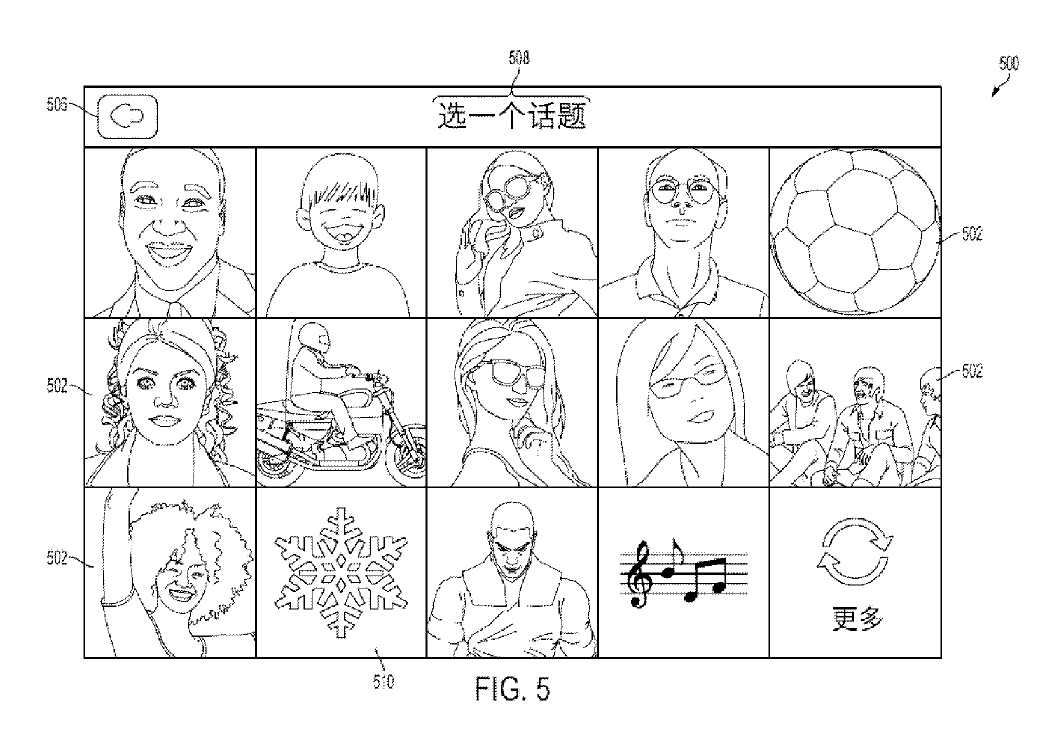

FIGS. 5-7 show exemplary user interfaces which may be displayed via the first language learning client, discussed above. It will be appreciated that FIGS. 5-7 may be exemplary embodiments of the method 400 shown in FIG. 4.

Specifically, FIG. 5 shows topic selection user interface 500 containing selectable topic widgets 502. The topics are displayed as tiles, in the depicted example. Specifically, the topics are graphics (e.g., photos, drawings, etc.,) in the depicted example. However other topic representations have been contemplated. For instance, the topics may be represented via video, text (e.g., bilingual text), audio (e.g., bilingual audio). The topic widgets may be related to popular topics known to kids, in one instance. Thus, the topics may be related to contemporary celebrities, politicians, artists, music, sports, movies, television shows, etc. In another example, the topic selection user interface 500 may also be configured to receive topic widgets uploaded by the user of the language learning client. In this way, the user can provide relevant topics which were not formerly available in the interface.

The mixed language user interface 500 includes a return widget 506 which enables a user to navigate to an earlier interface, in one example. The topic selection user interface 500 also includes text 508. The text may prompt a user to select a topic widget. In the depicted example, the user selects one of the topic widgets indicated at 510.

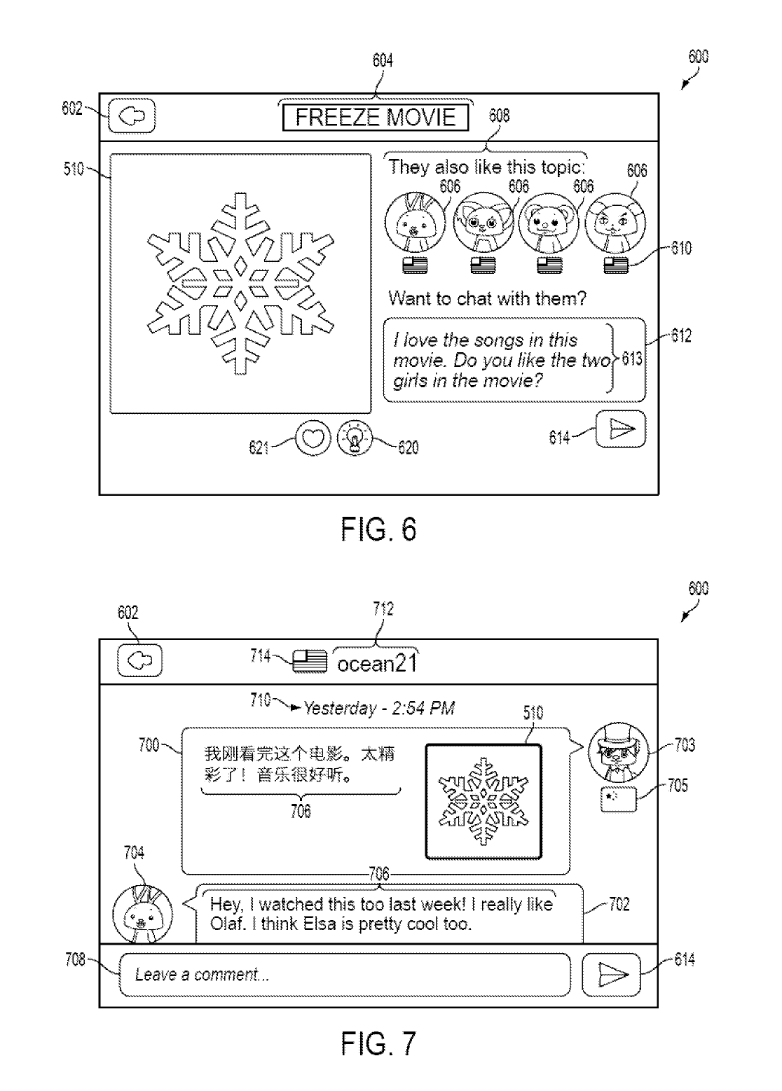

FIG. 6 shows an example mixed language user interface 600 which may be displayed via a language learning client, such as one of the language learning clients discussed above (i.e., client 12, 14, and/or 16). The mixed language user interface 600 may displayed by the language learning client responsive to the selection of the topic widget 510 shown in FIG. 5.

Again, the mixed language user interface 600 includes a return widget 602 which enables a user to navigate to a previously accessed interface, in one example. Additionally, the mixed language user interface 600 includes the selected topic widget 510. The mixed language user interface 600 also includes text 604 related to the selected topic widget 510. In this way, the topic is a movie. However, it will be appreciated that any suitable topics may be provided in the interface. The mixed language user interface 600 further includes avatar graphics 606 representing other users of language learning clients. It will be appreciated, that the other language learning clients may be automatically chosen based on the topic widget 510 selected via the topic selection user interface 500 shown in FIG. 5. Continuing with FIG. 6, the avatars are virtual representations of the users of the other client devices. Text 608 is also presented in the mixed language user interface 600 which conveys to the user the avatars 606 related interest in the topic which they selected. Flags 610 or other suitable native language indicators may also be presented below the avatars to convey the avatars nationality and therefore native language.

A text input field 612 (e.g., bilingual text input field) is also provided in the interface 600. In the depicted example, the user enters text input 613 in a foreign language. However, in other examples the user may enter the text input in their native language. A “send” widget 614 is also presented in the mixed language user interface 600. The “send” widget is configured to initiate delivery of the text in the input field 612 to an intended recipient. The intended recipient may be an avatar selected from the plurality of avatars 606. An “info” widget 620 is also provided in the mixed language user interface 600. The “info” widget is configured to display a bilingual introduction to the topic widget 510. A “like” widget 621 is provided in the interface which enables users to identify topics or other aspects of the interface that they like. The “like” data may then be catalogued and stored. Additionally, the stored “like” data may be used to subsequently match language learning clients, in one example.

FIG. 7 shows the mixed language user interface 600 shown in FIG. 6 after a recipient (i.e., avatar) for a message entered into the input field 612, shown in FIG. 6, is selected. The selected topic widget 510 is adjacent to a message 700 provided in the user's native language. It will be appreciated that the message may correspond to the text input 613, shown in FIG. 6. An auto-translation function executed via the language learning platform or language learning client may be used to change the text from the foreign language to the native language or vice-versa. An avatar 703 of the user of the language learning client displaying the interface 600 is also presented in the interface. A flag 705 representing the user's country and therefore native language is also displayed in the interface.

A response message 702 is also presented in the mixed language user interface 600. It will be appreciated that the response message may be provided by a user of a second language learning client associated with the avatar 704. As shown text 706 is provided in a first language, which in this case is Chinese, and a second language, which in this case is English. However, any other languages spoken across the globe may be used. It will be appreciated that text may include language symbols such as characters, alpha-numeric symbols, etc. In this way, a bilingual dialogue between two participants speaking different native languages is enabled. Consequently, the participant's comprehension of the foreign language is increase. Moreover, the dialogue is prompted via a common interest topic, thereby enabling the participants to find a commonality to enter into a conversation to overcome cultural and social barriers. As a result, the participants may be more engaged in the dialogue (e.g., chat), further enhancing their foreign language comprehension.

Another input field 708 is provided to the user to enter a new message to carry on with the dialogue. Again the “send” widget 614 is provided in the interface which enables a message entered into the input field 708 to be sent to the other participant. Additionally, the messages are also time stamped and dated at 710. The user name 712 of the avatar 604 is also presented in the mixed language user interface 600 along with a flag 714 representing their nationality.

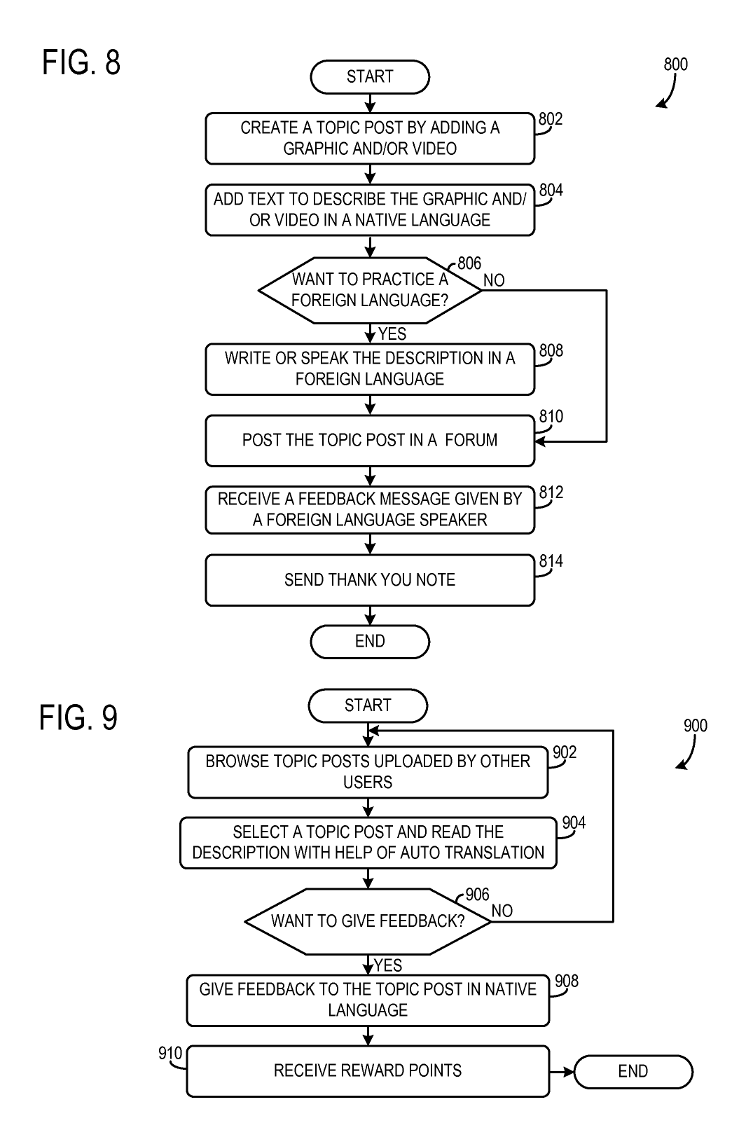

FIG. 8 shows a method 800 for foreign language learning. Specifically, the method 800 shows a way in which a user of a mixed language user interface may receive feedback. The method 800 may be implemented via the system, platform, components, modules, services, etc., described above with regard to FIGS. 1 and 2 or may be implemented via other suitable systems, platforms, components, modules, services, etc. In particular, it will be appreciated that the method may be implemented via a first language learning client and a language learning platform.

At 802 the method includes creating a topic post by adding a graphic and/or video. Next at 804 the method includes adding text to describe the graphic and/or video in a native language. The text may be incorporated into the topic post, in one example.

Next at 806 the method includes determining if a user wants to practice a foreign language. If it is determined that the user wants to practice a foreign language (YES at 806) the method advances to 808 where the method includes writing or speaking the description of the graphic and/or video in a foreign language. It will be appreciated that the foreign language description may be incorporated into the topic post, in one example. After 808 the method advances to 810. Additionally, if it is determined that the user does not wants to practice a foreign language (NO at 806) the method proceeds to 810. At 810 the method includes posting a topic post in a forum where participants share similar interests. It will be appreciated that the forum may be provided via the language learning platform. Next at 812 the method includes receiving a feedback message given by a foreign language speaker. It will be appreciated that the foreign language speaker, speaks the foreign language natively. Next at 814 the method includes sending a thank you note to the foreign language speaker who provided the feedback message.

FIG. 9 shows a method 900 for foreign language learning. Specifically, the method 800 shows a way in which a user of a mixed language user interface may provide feedback. The method 900 may be implemented via the system, platform, components, modules, services, etc., described above with regard to FIGS. 1 and 2 or may be implemented via other suitable systems, platforms, components, modules, services, etc. In particular, it will be appreciated that the method may be implemented via a second language learning client and a language learning platform.

At 902 the method includes browsing topic post uploaded by other users. It will be appreciated that the users may be users of language learning clients and the topic posts may be uploaded into a mixed language user interface.

Next at 904 the method includes selecting a topic post and reading the description in the post with help of auto translation. However, in other example the auto translation may not be used.

At 906 the method determines if the user wants to give feedback. If the user does not want to give feedback (NO at 906) the method returns to 902. However, if the user wants to give feedback (YES at 906) the method advances to 908. At 908 the method includes giving feedback to the topic post in a native language. At 910 the user may receive reward points from the language learning platform. Additional or alternate types of reward data may be provided to the user response to feedback given by the user. Other types of reward data include ratings data.

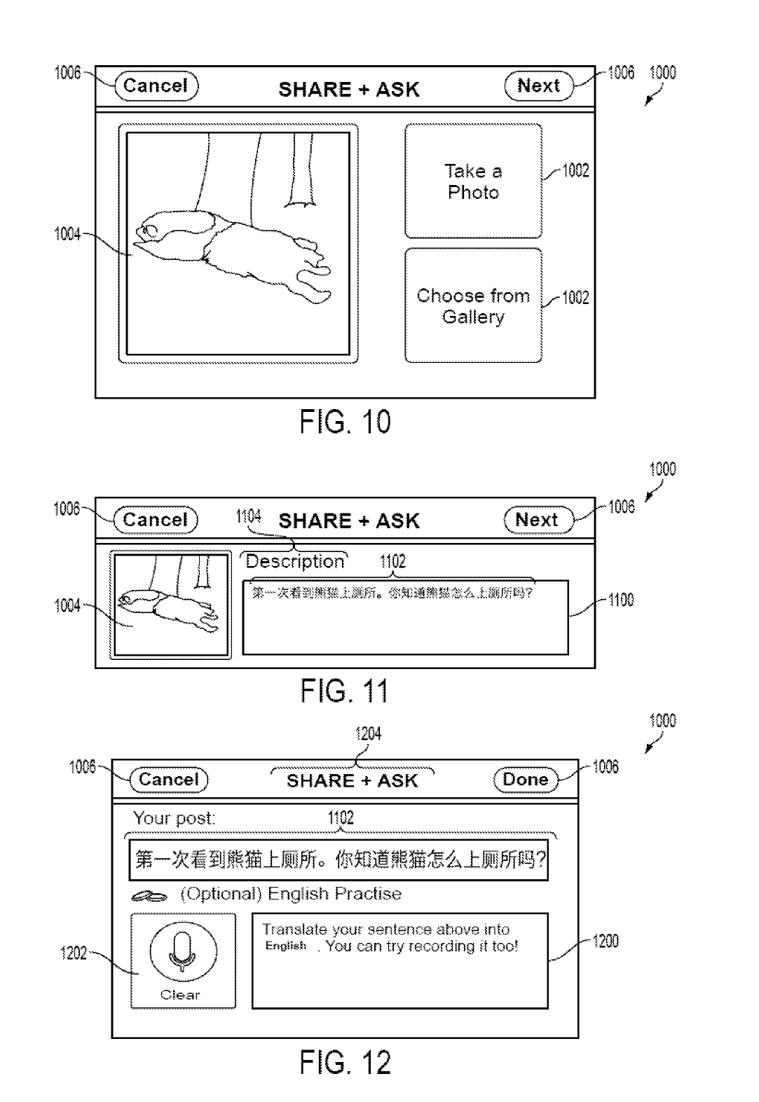

FIGS. 10-13 show a mixed language user interface which may be used to receive feedback. Thus, FIGS. 10-13 may be example embodiments of the method 800 shown in FIG. 8. Specifically, FIG. 10 shows a mixed language user interface 1000. The mixed language user interface 1000 includes widgets 1002 configured to receive photos or other suitable graphics. The text illustrated in the mixed language user interface is in English. However, it will be appreciated that the text may be presented in two languages, in other examples. For instance, the text may be in English and Chinese. As shown, the photos may be uploaded, chosen from a gallery, and/or taken via a camera integrated into or associated with the client device. An uploaded picture is shown at 1004. However, it will be appreciated that other suitable graphics and/or videos may be uploaded. The graphics and/or videos may be generally referred to as topic posts. Functional buttons 1006 enabling the user to cancel the upload or proceed to the next upload may also be provided in the mixed language user interface 1000. FIG. 10 shows a way in which a user may upload a photo or other suitable topic post. After the topic post is uploaded the user can enter a description of the photos as shown in FIG. 11.

As illustrated, the mixed language user interface 1000 in FIG. 11 includes a text input field 1100. As shown, descriptive text 1102 is provided in the field 1100 is in the user's native language, which in this case is Chinese. Furthermore, the descriptive text 1102 may be a description related to the photo 1004. In this way, the visual content may be associated with a description to increase comprehension of the text by non-native language speakers whom may view the topic post, at a later time.

Additionally, foreign language text 1104 is also provided in a foreign language. The text 1104 may guide the user to enter the descriptive text 1102. When text is provided in both a native and foreign language the user can practice foreign language comprehension. Again, the functional buttons 1006 are provided in the mixed language user interface 1000 shown in FIG. 11. After the text description of the topic post which in this case is a photo is entered into the interface 1000 the user also may be prompted to translate the descriptive text into a foreign language as shown in FIG. 12.

A text input field 1200 is provided in the mixed language user interface 1000 shown in FIG. 12. The text input field 1200 guides the user to translate the descriptive text 1102 related to the photo 1004, shown in FIG. 11, into a foreign language, which in this case is English. Additionally, an audio widget 1202 may also be provided to enable the user to enter an audio description of the descriptive text 1102 in the foreign language. This translation may be optional to the user. Therefore in one example, the user may be rewarded via reward data such as points data, rankings data, etc., in response to entering a foreign language translation of the descriptive text 1102. In this way, a user may be incentivized to provide feedback. Again, the functional buttons 1006 are provided in the mixed language user interface 1000, shown in FIG. 12. A “share+ask” widget 1204 may be provided in the mixed language user interface 1000 which enables the user to post the topic post. Thus, the topic may be shared with other client in the system to prompt feedback. It will be appreciated that the topic post may include the photo 1004, shown in FIG. 11, as well as the descriptive text 1102 and a translation text which may be entered into the text input field 1200.

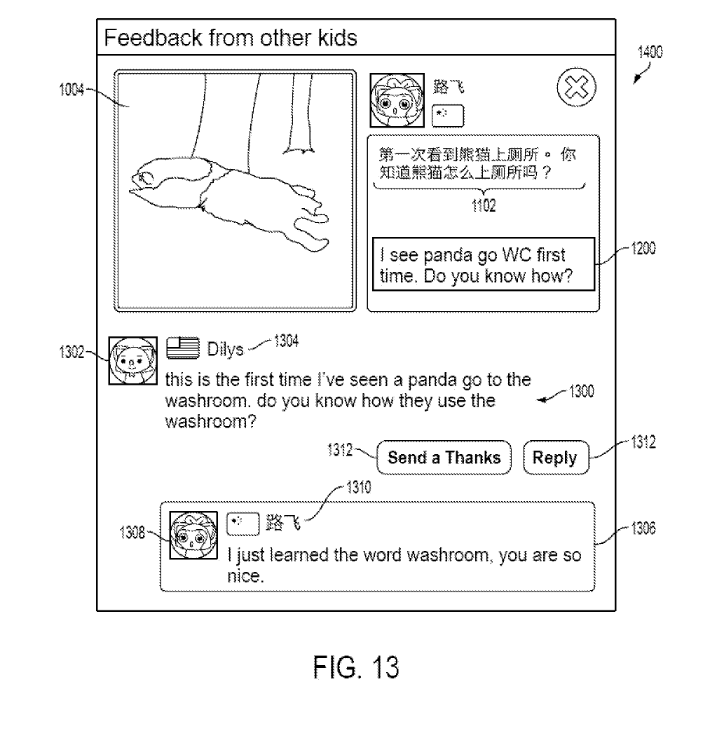

After the topic post is posted the user may receive feedback from other clients related to the topic post. The topic post may be posted in a forum or other viewable location by the language learning platform. FIG. 13 shows the mixed language user interface 1000 receiving a feedback message 1300 from another client represented via the avatar 1302 and username 1304. It will be appreciated that the feedback message may be related to the topic post which includes the photos 1004, the descriptive text 1102, and the translation text 1200. As previously discussed, the descriptive text provides a description of the photo in a user's native language and the translation text is a user's attempt at a translation of the descriptive text. The feedback message 1300 by the other user enables another user to provide feedback regarding the translation text to aid in language learning comprehension. FIG. 13 also shows a reply message 1306 to the feedback message 1300 provided from the user, represented via avatar 1308 and username 1310. The messages 1300 and 1306 are provided in a language that is foreign to the user, enabling them to practice conversing in the foreign language. As shown buttons 1312 are provided to enable the user to reply to the feedback message and sent a thank you message to the other client.

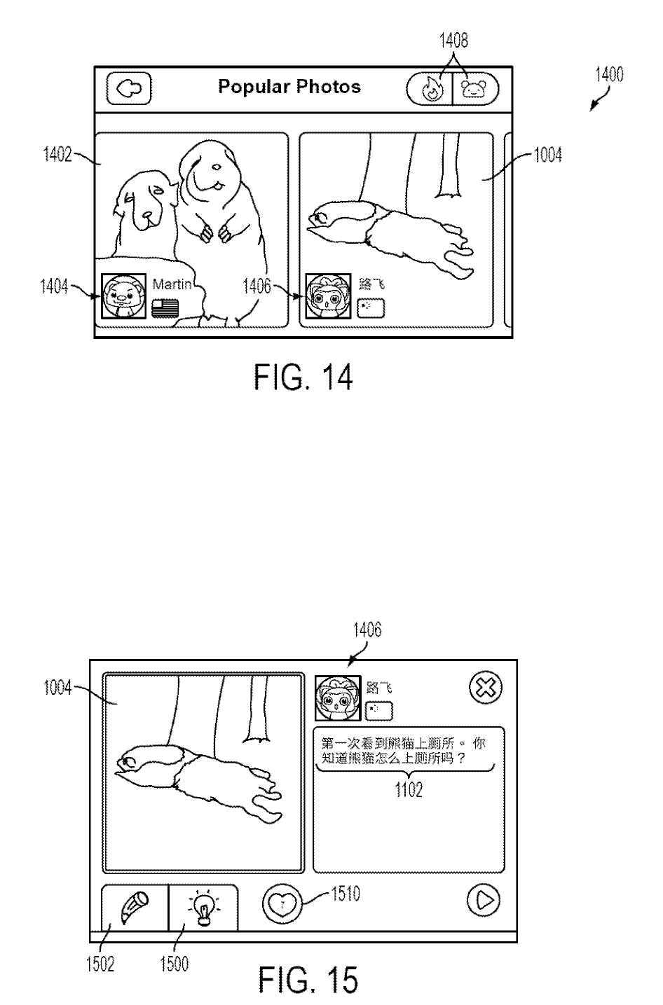

FIGS. 14 and 15 show a mixed language user interface 1400 which may be used to provide a feedback message related to a topic post. It will be appreciated that the mixed language user interface may be implemented from a second language learning client which is different from the first language learning client presenting the mixed language user interface 1000, shown in FIGS. 10-13. Specifically, FIG. 14 shows the mixed language user interface 1400 including a plurality of photos. As shown one of the photos 1402 is uploaded by a user 1404 and the photo 1004 uploaded by a user 1406. It will be appreciated that the user 1404 and the user 1406 are users of clients which are not displaying the mixed language user interface 1400. Buttons 1408 may be configured to enable users to view graphics previously uploaded by themselves, other users, and/or the language learning platform. One of the photos (1402 and 1406) may be selected by the user to enable the user to give feedback regarding the photo.

FIG. 15 shows the mixed language user interface 1400 after the user of the interface has selected a topic post (i.e., photo 1402). The descriptive text 1102 of the photo 1402 is also shown in FIG. 15. An auto translate button 1500 is also provided which enables the descriptive text to be translated into the user's native language. Additionally, a feedback button 1502 is provided to enable the user to provide a feedback message related to the topic post. In this way, a user may provide feedback related to the topic post to engage in a dialogue with other users. A “like” widget 1510 is also provided in the mixed language user interface 1400 and may have a similar functionality to the like widget previously described with regard to FIG. 6. The numeral “7” in the “like” widget 1510 indicates a number of “likes” of the topic post 1402.

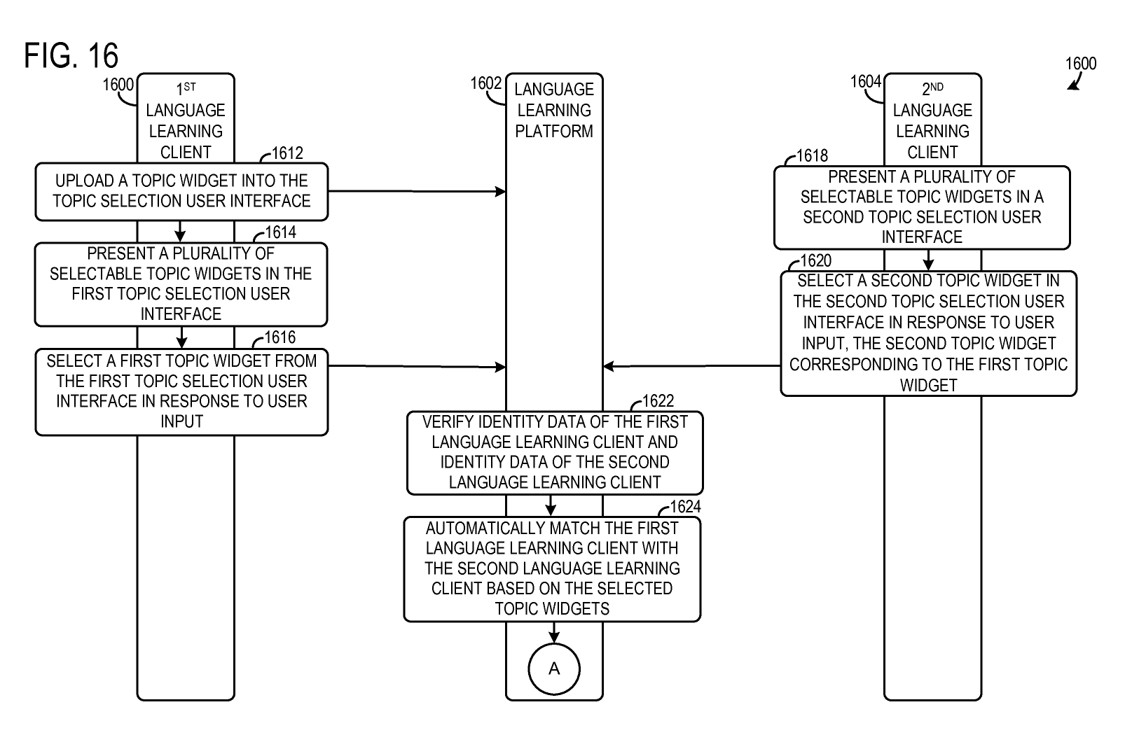

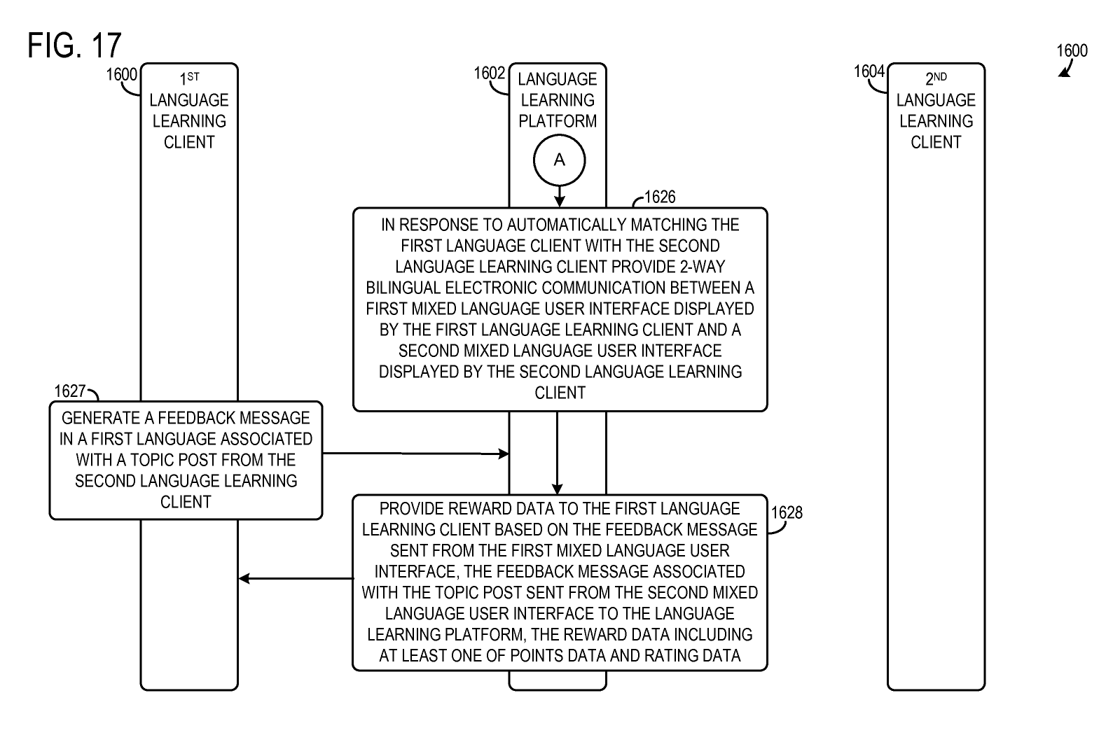

FIGS. 16-17 show a method 1610 for foreign language learning in a foreign language system. Specifically, the method 1610 is implemented via a first language learning client 1600, a language learning platform 1602, and a second language learning client 1602. It will be appreciated that the first language learning client 1600, the language learning platform 1602, and the second language learning client 1602 are in electronic communication with one another. Specifically in one example, the first language learning client 1600 may be in asynchronous electronic communication with the second language learning client 1604. It will be appreciated that the method 1610 may be implemented via the system, platform, components, modules, services, etc., described above with regard to FIGS. 1 and 2 or may be implemented via other suitable systems, platforms, components, modules, services, etc.

Referring to FIG. 16, at 1612 the method includes uploading a topic widget into the topic selection user interface. In the depicted example step 1612 is implemented via the 1^{st} language learning client. However, in other example step 1612 may be implemented via the language learning platform. Specifically in one example, the topics may be automatically selected via the language learning platform. The topic widget may include graphics (e.g., photos, drawings, etc.), video, and/or a text (e.g., bilingual text). In this way, a user of the 1^{st} language learning client can upload a topic that they are interested in. It will be appreciated that the uploaded topic widget is sent to the language learning platform and may be posted in a forum or other suitable location. This action is denoted via an arrow.

Next at 1614 the method includes presenting a plurality of selectable topic widgets in the first topic selection user interface. It will be appreciated that the first topic selection user interface presented via the first language learning client 1600. Next at 1616 the method includes selecting a first topic widget from the first topic selection user interface in response to user input. It will be appreciated that the language learning server is notified of the topic selected via the first language learning client. This action is denoted via an arrow.

At 1618 the method includes presenting a plurality of selectable topic widgets in a second topic selection user interface, at the second language learning client. At 1620 the method includes selecting a second topic widget in the second topic selection user interface in response to user input, the second topic widget corresponding to (e.g., matching) the first topic widget. In some cases, the corresponding topics may be associated topics. In one particular case, the corresponding topics may be identical topics and therefore match one another. However in other examples, the corresponding topics may be generally related to one another. It will be appreciated that the language learning server is notified of the topic selected via the second language learning client.

Next at 1622 at the language learning server, the method includes verifying identity data of the first language learning client and identity data of the second language learning client. In this way, identity verification is implemented to reduce the likelihood of unauthorized access to the language learning server.

Next at 1624 the method includes automatically matching the first language learning client with the second language learning client based on the selected topic widgets. Specifically, in one example clients having related selected topics may be matched up. For instance, the first language learning client may be automatically matched with the second language learning client when the first topic widget is associated with the second topic widget. Still further in one example clients having identical selected topics may be matched up. That is to say that the first language learning client may be automatically matched with the second language learning client when the first topic widget is identical to the second topic widget, in one example. In yet another example, automatically matching the first language learning client with the second language learning client may be based on at least one of age data, school data, foreign language data, nationality data, location data, and personal interest data. Additionally, an augmented interested graph may be used in a matching algorithm providing the automatic matching functionality.

Now referring to FIG. 17, at 1626 the method includes in response to automatically matching the first language client with the second language learning client providing 2-way bilingual electronic communication between a first mixed language user interface displayed by the first language learning client and a second mixed language user interface displayed by the second language learning client. In one example, the communication may be asynchronous, as previously discussed. It will be appreciated that bilingual communication may include enabling each of the interfaces to send and receive messages in both their native language and foreign language, respectively. In this way, peers may be linked up based on a common topic of interest, enabling the peers to engage in a multi-cultural exchange. As a result, the language learning comprehension for both parties involved in the dialogue is enhanced. Specifically in one example, the first and second mixed language user interfaces include one or more of bilingual text input fields, bilingual text, graphics, and video. Further in such an example, at least a portion of one or more of the bilingual text, graphics, and video are associated with one of the selected topic widgets. Still further in such an example, the bilingual text includes language symbols (e.g., characters, alpha-numeric symbols, etc.,) in a first language being a native language of the learning client and language symbols (e.g., characters, alpha-numeric symbols, etc.,) in a second language being a native language of the second language learning client, the second language different from the first language.

At 1627 the method includes generating a feedback message in a first language associated with a topic post from the second language learning client. In one example, the first mixed language user interface may be configured to provide a feedback message in the first language related to a topic post provided by the second mixed language user interface, the post including text in the first language and graphics associated with the text, the feedback message including at least one of text data and audio data.

Next at 1628 the method includes providing reward data to the first language learning client based on the feedback message sent from the first mixed language user interface associated with the topic post sent from the second mixed language user interface, the reward data including at least one of points data and rating data. In this way, the first client may be incentivized to respond to posts from other clients via rewards. As discussed above, the method steps described herein may be stored in memory as instructions executable via a processor.

It will be appreciated that methods described herein are provided for illustrative purposes only and are not intended to be limiting. Accordingly, it will be appreciated that in some embodiments the methods described herein may include additional or alternative processes, while in some embodiments, the methods described herein may include some processes that may be reordered, performed in parallel or omitted without departing from the scope of the present disclosure. Further, it will be appreciated that the methods described herein may be performed using any suitable software and hardware including the specific examples described herein.

This written description uses examples to disclose the invention, including the best mode, and also to enable a person of ordinary skill in the relevant art to practice the present disclosure, including making and using any devices or systems and performing any incorporated methods. The patentable scope of the present disclosure is defined by the claims, and may include other examples as understood by those of ordinary skill in the art. Such other examples are intended to be within the scope of the claims.

1. A method for foreign language learning in a foreign language learning system comprising:
at a language learning platform, automatically matching a first language learning client with a second language learning client based on a topic widget selected in a topic selection user interface, the topic selection user interface displayed by the first language learning client, and the first language learning client in electronic communication with the language learning platform; and
in response to automatically matching the first language client with the second language learning client providing 2-way asynchronous bilingual electronic communication between a first mixed language user interface displayed by the first language learning client and a second mixed language user interface displayed by the second language learning client;
where the first and second mixed language user interfaces include one or more of bilingual text input fields, bilingual audio recording fields, bilingual text, bilingual audio, graphics, and video; and
the bilingual text includes language symbols in a first language that is a native language of the learning client and language symbols in a second language that is a native language of the second language learning client, the second language different from the first language; and
the bilingual audio includes speech in a first language that is a native language of the learning client and speech in a second language that is a native language of the second language learning client, the second language different from the first language.

2. The method of claim 1, where the topic widget includes at least one of graphics, video, bilingual text that describes the graphics and the video, and bilingual audio that describes the graphics and the video.

3. The method of claim 1, where the language symbols include at least one of characters and alpha-numeric symbols.

4. The method of claim 1, where at least a portion of one or more of the bilingual text, bilingual audio, graphics, and video are associated with the selected topic widget.

5. The method of claim 1, further comprising, prior to the automatically matching, at the language learning platform, uploading a topic widget into the topic selection user interface.

6. The method of claim 1, further comprising prior to automatically matching the first language learning client with the second language learning client;
at the first language learning client, presenting a plurality of selectable topic widgets in the first topic selection user interface; and
selecting the first topic widget from the first topic selection user interface in response to user input; and
at the second language learning client, presenting a plurality of selectable topic widgets in a second topic selection user interface; and
selecting a second topic widget in the second topic selection user interface in response to user input, the second topic widget matching the first topic widget;
where the automatic matching is based on the selection of the first topic widget and the second topic widget.

7. The method of claim 1, prior to automatically matching the first language learning client, at the language learning platform, verifying identity data of the first language learning client and identity data of the second language learning client and in response to verifying identity data permitting the automatically matching.

8. The method of claim 1, at the language learning platform, providing reward data to the first language learning client based on a feedback message sent from the first mixed language user interface, the feedback message associated with a topic post sent from the second mixed language user interface to the language learning platform, the feedback message including at least one of text data and audio data, the reward data including at least one of points data and rating data.

9. The method of claim 1, further comprising, prior to the automatically matching, at the first language learning client, uploading a topic widget into the topic selection user interface.

10. The method of claim 1, where automatically matching the first language learning client with the second language learning client is based on at least one of age data, school data, foreign language data, nationality data, location data, and personal interest data.

11. A foreign language learning system comprising:
a first language learning client configured to display a topic selection user interface including a plurality of topic widgets, receive a topic selection input of a selected topic widget; and
a language learning platform in electronic communication with the first language learning client configured to automatically match the first language learning client with a second language learning client based on the selected topic widget and configured to provide 2-way bilingual electronic communication between the first language learning client and the second language learning client in response to the automatic matching.

12. The foreign language learning system of claim 11, where the topic widget includes at least one of graphics, video, and bilingual text describing the graphics and the video.

13. The foreign language learning system of claim 11, where the electronic communication between the first language learning client, the language learning platform, and the second language learning client is asynchronous electronic communication.

14. The foreign language learning system of claim 11, where the 2-way bilingual communication is displayed via a first mixed language user interface executed by the first language learning client and displayed via a second mixed language user interface executed by the second language learning client.

15. The foreign language learning system of claim 14, where the first and second mixed language user interfaces include one or more of bilingual text input fields, bilingual audio recording field, bilingual text, bilingual audio, graphics, and video, the bilingual text includes language symbols in a first language being a native language of the first language learning client and language symbols in a second language being a native language of the second language learning client, the second language different from the first language, the bilingual audio includes speech in a first language being a native language of the first language learning client and speech in a second language being a native language of the second language learning client, the second language different from the first language.

16. The foreign language learning system of claim 15, where first mixed language user interface is configured to provide a feedback message in the first language related to a topic post provided by the second mixed language user interface, the post including text in the first language and graphics associated with the text, the feedback message including at least one of text data and audio data.

17. The foreign language learning system of claim 15, where one or more of the bilingual text, bilingual audio, graphics, and video corresponds to the selected topic widget.

18. A method for foreign language learning in a foreign language learning system stored in memory as instructions executable by a processor, the method comprising:
at a language learning platform, automatically matching a first language learning client with a second language learning client when a first topic widget is associated with a second topic widget, the first topic widget selected in a topic selection user interface displayed by the first language learning client in electronic communication with the language learning platform and the second topic widget selected in a topic selection user interface displayed by the second language learning client in electronic communication with the language learning platform; and
in response to automatically matching the first language client with the second language learning client enabling 2-way asynchronous bilingual electronic communication between a first mixed language user interface executed by the first language learning client and a second mixed language user interface executed via the second language learning client;
where the first and second mixed language user interfaces include one or more of bilingual text input fields, bilingual audio recording fields, bilingual text, bilingual audio, graphics, and video; and
the bilingual text input fields and the bilingual text receiving or including language symbols in a first language being a native language of the first language learning client and language symbols in a second language being a native language of the second language learning client, the second language different from the first language; and
the bilingual audio recording fields and the bilingual audio receiving or including speech in a first language being a native language of the first language learning client and speech in a second language being a native language of the second language learning client, the second language different from the first language.

19. The method of claim 18, further comprising, at the first language learning client generating a feedback message in a first language associated with a topic post from the second language learning client, the feedback message including at least one of text data and audio data.

20. The method of claim 19, further comprising at the language learning platform providing reward data to the first language learning client in response to generating the feedback message, the reward data including at least one of points data and ratings data.
